(19) United States
(12) Patent Application Publication
(10) Pub. No.: US 2008/0283487 A1
(43) Pub. Date: Nov. 20, 2008

(54) PROCESS FOR PRODUCING THREE-DIMENSIONAL PHOTONIC CRYSTAL AND THE THREE-DIMENSIONAL PHOTONIC CRYSTAL

(75) Inventors: Shinan Wang, Kashiwa-shi (JP); Kenji Tamamori, Ebina-shi (JP); Taiko Motoi, Atsugi-shi (JP); Masahiko Okunuki, Akiruno-shi (JP); Haruhito Ono, Minamiashigara-shi (JP); Toshiaki Aiba, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/108,991

(22) Filed: Apr. 24, 2008

(30) Foreign Application Priority Data
May 15, 2007 (JP) 2007-129022

(51) Int. Cl. B32B 3/30; C23F 1/00

(52) U.S. Cl. 216/2; 428/167

(57) ABSTRACT

A process for producing a three-dimensional photonic crystal comprises the steps of providing a base material having first and second faces adjoining together at a first angle; forming a first mask on the first face; forming fine holes in the base material by dry-etching on the first face in a direction at a second angle to the first face; forming a second mask on the second face; and forming fine holes in the base material by dry-etching on the second face in a direction at a third angle to the second face; the first mask and the second mask, being formed by implantation of ions by a focused ion beam onto the surface layer of the mask formation face of the base material.

### BACKGROUND OF THE INVENTION

1. Field of the Invention

The present invention relates to a process for producing a three-dimensional photonic crystal, and the three-dimensional photonic crystal.

2. Description of the Related Art

The photonic crystal is a structure in which materials different in the refractive index are periodically distributed. The photonic crystal is an artificial material which enables a novel function (e.g., control of propagation of light, an electromagnetic wave having the wavelength of hundreds to thousands of nanometers) by simply adjusting the structure design.

The refractive index difference between the constituting materials, and the periodicity in the structure give, as the most important characteristic of the photonic crystal, a photonic band gap, namely a region through which a specified electromagnetic wave cannot propagate. A defect introduced appropriately into the refractive index distribution in the photonic crystal forms an energy level (defect level). Owing to this defect, the photonic crystal is capable of controlling propagation of an electromagnetic wave. Moreover, a device employing the photonic crystal can be made far smaller than conventional devices.

A three-dimensional photonic crystal has three-dimensional periodicity of the refractive index of the constitution material, being less liable characteristically to cause leakage of an electromagnetic wave from the defect position. Therefore, the three-dimensional photonic crystal is the most suitable material for controlling electromagnetic wave propagation.

A typical three-dimensional photonic crystal has a woodpile structure (or a rod-pile structure) as disclosed in U.S. Pat. No. 5,335,240. FIG. 6 illustrates the woodpile structure of this three-dimensional photonic crystal.

In FIG. 6, three-dimensional structure 300 is constituted of a stack of striped layers having respectively plural rods 301 arranged parallel and periodically at prescribed in-plane arrangement periods. The numeral 305 indicates a cross section of the rod.

This three-dimensional periodic structure is constructed of a stack of units of striped layers having a four-layer periodicity. One periodicity unit comprises four striped layers: a first striped layer contains plural rods placed parallel and periodically at an in-plane arrangement period; a second striped layer is laminated on the first striped layer and contains rods placed parallel periodically at the arrangement period in the direction perpendicular to the rods in the first layer; a third striped layer is laminated on the second striped layer and contains rods placed parallel to each other periodically in the direction parallel to the rods in the first layer but displaced by half the arrangement period from the rods of the first striped layer; and a fourth striped layer is laminated on the third striped layer and contains rods placed parallel to each other periodically in the direction parallel to the rods in the second layer but displaced by half the arrangement period from the rods of the second striped layer. The sets of the striped layers are stacked to constitute the three-dimensional periodic structure.

The rod-arrangement period in the photonic crystal structure is about a half of the wavelength to be controlled. For example, in the photonic crystal device for control of visible light, the in-plane arrangement period of the rods is about 250 nm.

For formation of a photonic band gap in a broader wavelength range, U.S. Pat. No. 6,993,235 discloses a joint-rod type of the three-dimensional photonic crystal structure 300 as illustrated in FIGS. 7A and 7B. This three-dimensional photonic crystal structure 300 has joint portions 320 having an area larger than the area of the crossing region at the crossing point of the rod portions 310 corresponding to the rod of the woodpile structure.

Such a three-dimensional photonic crystal having a fine three-dimensional structure, although expected to have ideal device characteristics, has a complicated structure, and the production process thereof includes many complicated steps. For controlling a shorter wavelength of an electromagnetic wave, the required structural period should be shorter, and the critical dimension (CD) for the required structure should be smaller also. This requires strict precision in the positional alignment between the layers and in the structure working.

For producing a three dimensional photonic crystal of a wood-pile structure, Japanese Patent Application Laid-Open No. 2004-219688 discloses a method of thermal adhesion of different members by a lamination technique. In this thermal adhesion method, firstly on a striped layer formed on a substrate, a rod array is formed parallel thereto in a predetermined period length, and then another striped layer is bonded thereto with positional alignment of the layer, and the substrate of one of the striped layers is removed. By repeating such steps, a wood-pile structure is produced which has layers in number of repetition of the adhesion. This lamination technique enables production of three-dimensional photonic crystal having a relatively complicated construction.

Applied Physics Letters 86, 011101 (2005) discloses still another method for producing a three-dimensional photonic crystal. In this method, a crystal of silicon is etched at a first face photoelectrochemically, and a second face of the crystal is worked by FIB to remove a part of the silicon to form a three-dimensional photonic crystal.

On the other hand, regarding a conventional thin film working process, U.S. Pat. No. 5,236,547 discloses a method of pattern formation and a method of producing a semiconductor element. In this disclosure, a thin film is worked through ion-beam implantation and dry etching. In the ion beam implantation, the position of focusing the ion beam on the material to be etched is moved and at least one of the accelerating voltage, the ion atomic species, and the ion valency is changed to form an ion concentration peak region in the depth direction of the etching object. In the dry etching step, the object material is etched by an etching gas which forms an etching inhibition region with the ion at the ion concentration peak region.

The three-dimensional photonic crystal, for achieving intended device characteristics, should have a prescribed number of the arrangement periods in the thickness direction as well as in the in-plane direction. Generally, the number of the arrangement periods in the thickness direction is 3 or more. Thus the aforementioned woodpile structure should have a lamination structure of 12 (3 four-layer periods) or more striped layers. Further, for achieving intended device characteristics, the working error and the layer alignment error in the structure should be made smaller.

In a woodpile structure of the three-dimensional photonic crystal, for example, the working error of each of the rods is preferably not larger than about 10% of the rod arrangement period, and the positional alignment error between the layers is preferably not larger than about 25% of the rod arrangement period. For a photonic crystal device for visible light, in which the in-plane rod arrangement period is about 250 nm, the rod working error is not larger than about ±25 nm, and the layer alignment error is not larger than about ±60 nm.

However, for production of the three-dimensional photonic crystal through a conventional lamination process like that disclosed in Japanese Patent Application Laid-Open No. 2004-219688, although a conventional semiconductor technique can be applied, the process is complicated, and the number of the production steps increases in proportion to the number of layers of the photonic crystal to increase technical difficulty and to lower the productivity. Moreover, alignment of the layer should be conducted in each of the lamination operations, which will inevitably accumulate the alignment errors. Moreover, at the interfaces between the layers, simultaneously with occurrence of discontinuity of the materials (or refractive index), dirt adhesion or contamination can occur unavoidably in the production process, causing undesired scattering of electromagnetic waves. Furthermore, increase of the number of the layers will increase stress in the structure to cause deformation of the structure. Such disturbances in the structure affect adversely the characteristics of the photonic crystal device.

Thus, conventional lamination process mentioned above cannot precisely produce a three-dimensional photonic crystal.

Applied Physics Letters 86, 011101 (2005) describes formation of three-dimensional photonic crystal from silicon crystal by photoelectrochemical (PEC) etching and FIB working. This process has the problems below.

Firstly, selection of the material of the base material is limited. When PEC etching is employed, the material should be selected which can be etched photoelectrochemically, and the crystal face for the etching and the shape of the holes are also limited. Therefore, the freedom degree in design and working is lower.

Secondly, in FIB working for formation of the three-dimensional photonic crystal, broken pieces of the base material sputtered by the ions can deposit again on the lateral walls of the fine holes unavoidably. Further, in the FIB working, a part of the ions are scattered and penetrates through the side walls of the fine holes into the base material of the photonic crystal to deteriorate the optical and electrical characteristics. Furthermore, the FIB which works the fine holes one by one is not suitable for working of a large area, so that a large three-dimensional photonic crystal cannot readily be formed at a low cost only by the FIB working.

A conventional thin film working method as disclosed in U.S. Pat. No. 5,236,547 is capable of working in the depth direction of the etching object material. However, such a technique is not applicable in production of the three-dimensional photonic crystal having a complicated structure like the woodpile structure.

The present invention intends to provide a process for producing a complicated three-dimensional structure, especially a three-dimensional structure of a nano-photonic crystal precisely and simply at a low cost. The present invention intends also to provide a three-dimensional photonic crystal capable of improving the device characteristics.

### SUMMARY OF THE INVENTION

The present invention provides a process for producing a three-dimensional photonic crystal having the constitution below, and a three-dimensional photonic crystal to solve the above problem.

The present invention is directed to a process for producing a three-dimensional photonic crystal comprises the steps of: providing a base material having first and second faces adjoining together at a first angle; forming a first mask on the first face; forming fine holes in the base material by dry-etching on the first face in a direction at a second angle to the first face; forming a second mask on the second face; and forming fine holes in the base material by dry-etching on the second face in a direction at a third angle to the second face; the first mask and the second mask, being formed by implantation of ions by a focused ion beam onto the surface layer of the mask formation face of the base material.

The base material of the three-dimensional photonic crystal can be formed from monocrystalline or amorphous Si or a Si compound.

The ions can be Ga ions or In ions.

The process for producing a three-dimensional photonic crystal can further comprise the steps of: forming a coating film on at least a part of the face of the base material before formation of the first and second masks, and removing at least a part of the coating film by etching treatment selectively after the formation of the first and second masks. The step of forming the coating film can be conducted by heat-treating the base material in an ambient gas to allow the surface component of the base material to react with the ambient gas to form an oxide film or nitride film on at least a part of the surface of the base material.

In the steps of forming fine holes in the first face and the second face of the base material, the dry etching can be conducted by reactive ion etching with a fluorine type gas.

In the step of providing the base material, the first angle can range from 10° to 170°.

The second angle and the third angle can range respectively from 10° to 90°.

In formation of the second mask, the second mask can be formed at a position not to overlap or to overlap partly with the first mask at the adjoining edge line between the first face and the second face. In the process, an alignment marker can be formed on the first face for alignment in the formation of the second mask.

The present invention is directed to a three-dimensional photonic crystal having a three-dimensional periodic structure constructed of sets of striped layers seamlessly stacked in a layer thickness direction, one set of the striped layers comprising four striped layers: a first striped layer containing plural columns arranged parallel and periodically at an in-plane arrangement period; a second striped layer being laid on the first striped layer and containing columns arranged parallel periodically in the direction different from the arrangement direction of the columns in the first striped layer; a third striped layer being laid on the second striped layer and containing columns arranged parallel to each other periodically in the direction parallel to the columns in the first layer but displaced by half the arrangement period from the columns of the first striped layer; and a fourth striped layer being laid on the third striped layer and containing columns arranged parallel to each other periodically in the direction different from the arrangement direction of the columns in the second layer but displaced by half the arrangement period from the columns the second striped layer.

The columns in the striped layers can have different cross-sectional shapes. The columns in the striped layers can have respectively a uniform cross-sectional shape and a uniform cross-sectional area along the column length direction.

The columns in the striped layers can have respectively a hollow.

In the three-dimensional photonic crystal, a joint portion can be placed at the respective crossing regions of the columns extending in different directions, the joint portion having an area larger than that of the crossing region and being placed in the direction of the column length.

The present invention enables production of a complicated three-dimensional structure, especially a three-dimensional structure of a nano-photonic crystal precisely and simply at a low cost. The present invention realizes a three-dimensional photonic crystal capable of improving the device characteristics.

Further features of the present invention will become apparent from the following description of exemplary embodiments with reference to the attached drawings.

### BRIEF DESCRIPTION OF THE DRAWINGS

FIGS. 1A, 1B, 1C, 1D, 1E, 1F, 1G, 1H, 1I and 1J are drawings for describing an embodiment of the process of production of the three-dimensional periodic structure of the present invention and in Example 1.

FIGS. 2A, 2B, 2C, 2D, 2E, 2F, 2G, 2H, and 2I are drawings for describing the process for producing the three-dimensional periodic structure of Example 2.

FIG. 3 illustrates the shapes of the cross-section of the columns of the three-dimensional periodic structure in Example 3 of the present invention.

FIGS. 4A and 4B are drawings illustrating the shapes of the mask for producing the three-dimensional periodic structure in Example 4 of the present invention.

FIGS. 5A and 5B are drawings illustrating the shapes of the mask for producing the three-dimensional periodic structure in Example 4 of the present invention.

FIG. 6 is a schematic drawing for describing a conventional woodpile structure of a three-dimensional photonic crystal.

FIGS. 7A and 7B illustrate a joint-rod type of a conventional three dimensional photonic crystal structure.

### DESCRIPTION OF THE EMBODIMENTS

The best mode for practicing the present invention is described below with reference to drawings. In the drawings, the same elements are denoted by the same numerals and symbols.

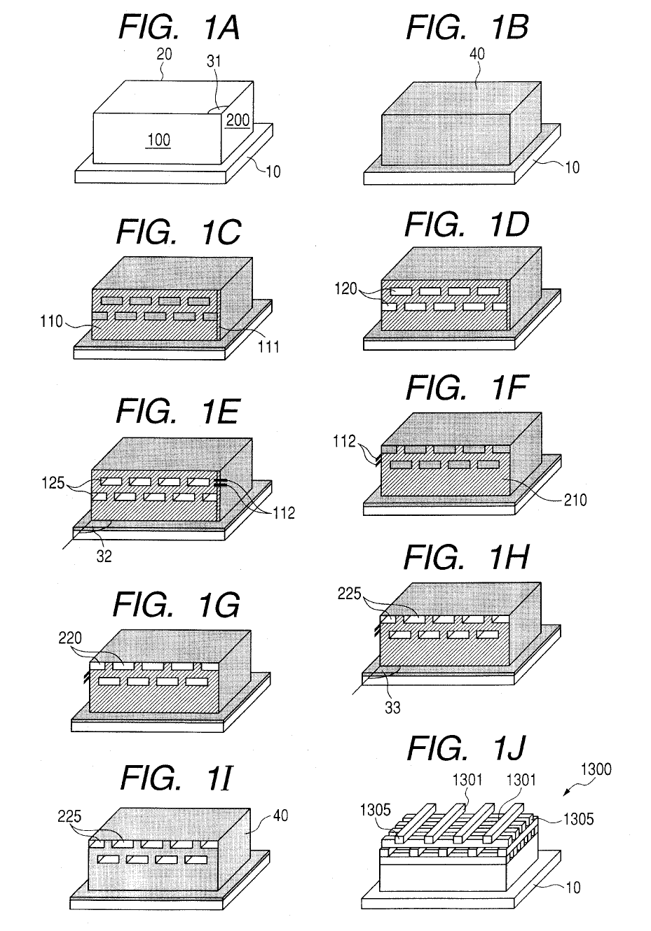

FIGS. 1A-1J illustrate a process for producing a three-dimensional periodic structure of an embodiment of the present invention.

In FIGS. 1A-1J, the numerals denote the followings: 10, a substrate; 20, a photonic crystal base material (also called a precursor); 100, a first face of the photonic crystal base material; 200, a second face of the photonic crystal base material adjoining to the first face; 31, a first angle of adjoining between first face 100 and second face 200.

First face 100 and second face 200 signify respectively a face to be worked of the base material constituting the photonic crystal in a polyhedron shape. First face 100 and second face 200 join together. The first and second faces to be worked are selected suitably in consideration of design of the photonic crystal, ease of the working (handling), the working scale, the working cost, and so forth.

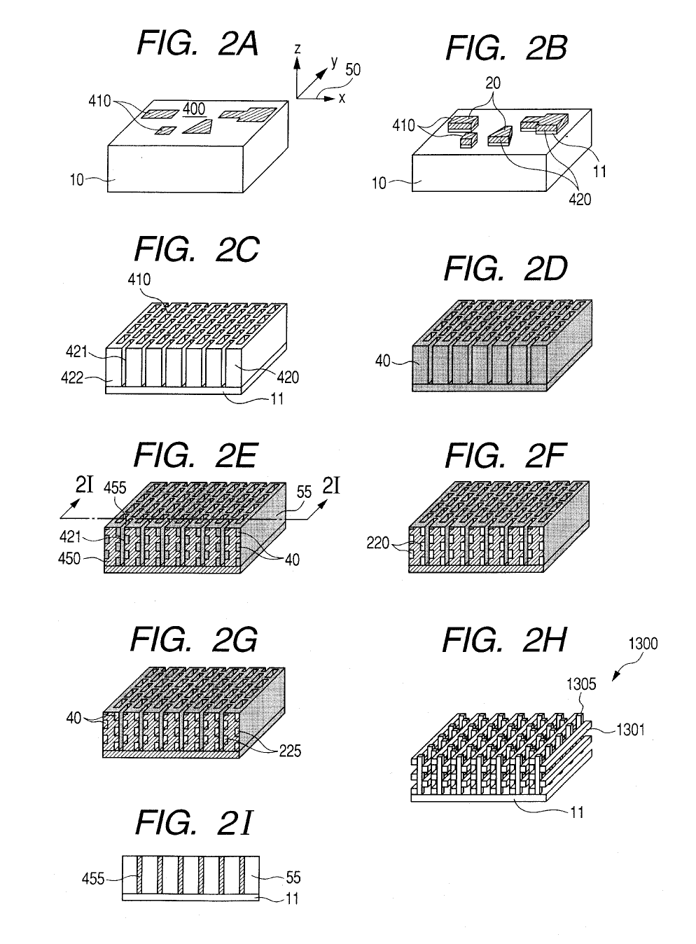

In the embodiment of the present invention, working of the faces of the photonic crystal may be conducted on a lateral face (end face) and another lateral face adjoining thereto as illustrated in FIG. 1A-1J, or may be conducted on the main face (top face or surface) and a lateral face adjoining thereto as illustrated in FIGS. 2A-2H.

The adjoining angle between first face 100 and second face 200 is not limited to the right angle, but may be selected corresponding to the design of the intended photonic crystal in the angle range from 10° to 90°. The adjustment of the adjoining angle between first face 100 and second face 200 gives greater flexibility in design of the photonic crystal.

The process for producing the photonic crystal of the present invention is described below specifically with reference to FIGS. 1A-1J.

As illustrated in FIG. 1A, base material 20 for the photonic crystal is prepared which has a first face and a second face adjoining to each other at a first angle. Base material 20 is worked by a conventional semiconductor working technique. Base material 20 may be turned out from substrate 10, or may be prepared from another material and bonded onto substrate 10. The suitable material for base material 20 may be a single crystalline or amorphous Si or a compound of Si (e.g., SiO₂, and SiN). The size of base material 20 ranges preferably from 1 μm to 1000 μm in length, breadth, and height, respectively. Adjoining angle 31 between first face 100 and second face 200 ranges preferably from 10° to 170°.

Before the subsequent step of forming a first mask, as illustrated in FIG. 1B, coating film 40 may be formed, as necessary, to coat the surface of base material 20 and substrate 10. Coating film 40 serves as a secondary mask or a strengthening mask in the later step of etching of the base material. However, this coating film formation may be omitted in consideration of the working accuracy, the material used, the etching conditions, the tact time, the formation cost, and so forth.

Coating film 40 is suitably formed by heat-treatment of base material 20 in a gas atmosphere to allow the surface component to react with the ambient gas to form an oxide or nitride film on the surface. For example, base material 20 composed of Si is heat-treated in an oxygen atmosphere at 1000° C. for 10 minutes to several hours to form a SiO₂ coating film of 10 nm to several μm thick on the surface of base material 20. The coating film for base material 20 can be formed otherwise by chemical vapor deposition, or atomic layer deposition.

In the next step of forming fine holes in the base material, as illustrated in FIG. 1C, first mask 110 is formed on first face 100 of the base material coated with coating film 40. In this first mask formation, for protection of the coating film on second face 200, protection mask 111 is preferably formed in a width nearly equal to the thickness of coating film 40 on the edge portion of first face 100 adjoining to second face 200. These masks, which are formed on the lateral face of base material 20, cannot be formed by a usual electron beam exposure process or a usual optical exposure process.

First mask 110 and protecting mask 111 are formed in a prescribed pattern by ion implantation into the surface layer of the mask formation face 100. The depth of the implantation is controlled by accelerating voltage of the ion beam, preferably in the range from 30 nm to 500 nm. Ideally, the implanted ion concentration is made maximum near the outermost part of the surface. Without coating film 40, the ions are injected directly into the surface layer of base material 20. In the presence of coating film 40, the injected ions may be kept in the surface layer of the coating film, or may be allowed to penetrate the coating film to reach the surface layer of the underlying base material. The implanted ions include Ga ions, and In ions. The maximum ion concentration in the coating film or the base material ranges preferably from 10¹⁹ to 10²³ cm⁻³, more preferably from 10²⁰ to 10²² cm⁻³. In such a manner, a mask pattern is formed on the surface layer of the mask formation face of the base material in a dimension accuracy of about 5 nm by ion implantation by a focused ion beam.

Next as illustrated in FIG. 1D, the pattern of first mask 110 is transferred onto coating film 40. Then, portions of the coating film where the ion implantation has not been conducted, or which have not been protected by first mask 110 are removed to form bared portions 120 of the first face.

When the coating film is formed from SiO₂, the dry etching of the coating film is conducted preferably by reactive dry etching with a fluorine-type gas or vapor phase etching with hydrofluoric acid vapor.

Here, the reason why the ion implantation portion functions as the mask is described by taking Ga ions as an example. In the fluorine-type gas or vapor, Ga reacts chemically with fluorine to form non-volatile Ga fluoride at the Ga-ion-implanted portion. The resulting Ga fluoride forms a protecting film on the surface of the portion as the mask to protect the coating film or the base material at that portion. The mask formed by Ga implantation of the present invention has sufficient masking effect at a relatively small amount of Ga implantation with small implantation depth, causing no or little damage of the worked object (base material) by ion implantation.

On the other hand, at non-ion-implanted portions not protected by first mask 110, the etching proceeds to remove the coating film or the base material.

This masking effect by the Ga fluoride formation can be achieved similarly also in direct implantation of Ga into photonic crystal base material 20 without coating film 40.

In the next step, fine holes are formed in the base material through the first mask formed on the first face. As illustrated in FIG. 1E, base material 20 is dry-etched at second angle 32 to bared portions 120 of the first face by masking with mask 110, mask 111 and coating film 40. By the dry etching, the portions of the base material not protected by mask 110, mask 111, and coating film 40 in the direction of second angle 32 are removed to form fine holes 125 in base material 20. Second angle 32 may be selected in the range from 10° to 90°, preferably from 80° to 90°. For the dry etching, RIE is preferred because the working by RIE is independent of the crystal orientation of the substance, and achieves high anisotropy. That is, the working proceeds predominantly in the projection direction of the etching particle beam (at second angle 32 to the first face). In this step also, the Ga fluoride gives the masking effect.

Next, a protecting film is formed on the inner wall of fine holes 125 (not shown in the figure). The protecting film is provided for decreasing a damage from succeeding steps to the inner wall of fine holes 125. The damage may be caused by e.g. scattered ions or dispersed radicals at the second etching of the fine holes. The thickness of the protecting film is preferably adapted to the succeeding steps so as to be adjusted to be as thin as possible, e.g. 10 to 500 nm. Where the size of fine holes 125 is changed by the formed protecting film, the shape of the mask is designed in the step of FIG. 1C to obtain the desired size as a result of the removing of the protecting film. While it is not necessary to accord the kind of material of the protecting film to that of coating film 40 in FIG. 1B, the accordance has a merit that the protecting film can be finally removed together with coating film 40. Further, the method of forming coating film 40 can be applicable to the forming of the protecting film. However, where the formation of the protecting film is not necessary in view of the accuracy in processing, the structure, the material, the etching condition, the tact-time, the forming cost and so forth regarding a photonic crystal to be obtained, the above forming process of the protecting film can be omitted.

Alignment marker 112 is formed on the first face to indicate the relative position of fine holes 125 formed on first face 100 to second face 200. The method of formation includes electron-beam-induced chemical vapor deposition (EB-CVD), and focused ion-beam-induced chemical vapor deposition (FIB-CVD). The constituting material of deposited marker 112 includes inorganic materials such as C and Si; metals such as W, Mo, Ni, Au, and Pt; oxides such as SiO₂; and compounds such as GaN. The deposited marker may contain an impurity. This marker 112 formed on the first face is utilized as an alignment marker in formation of the second mask.

In the next step, fine holes are formed in the base material. As illustrated in FIG. 1F, second mask 210 is formed on second face 200 of photonic crystal base material 20 in the same manner as in the above formation of first mask 110 on first face 100. The position of the second mask is adjusted relatively to the first mask by utilizing the above alignment marker 112. Through the entire process for formation of the three-dimensional photonic crystal, mask alignment is conducted only once, resulting in high working precision.

In the next step, as illustrated in FIG. 1G, the pattern of second mask 210 is transferred onto coating film 40. The portions of the coating film not covered with second mask 210 on the second face are removed to bare portions 220 of second face 200. The pattern transfer step is conducted in the same manner as the working process illustrated in FIG. 1D.

In the next step, as illustrated in FIG. 1H, fine holes are formed in the base material by etching through the second mask. In this fine hole formation, base material 20 is etched at bared portion 220 of second face 200 in the direction of third angle 33 by masking with second mask 210 and coating film 40. This etching is conducted in the same manner as that illustrated in FIG. 1E. By the etching, the portions of the base material not protected by mask 210 and coating film 40 are etched in the direction of third angle 33 to form fine holes 225 in base material 20. Third angle 33 may be selected in the range from 10° to 90°, depending on the intended structure of the photonic crystal and first angle 31 and second angle 32.

In the next step, as illustrated in FIG. 1I, first mask 110, second mask 210, second-face-protecting mask 111, and alignment marker 112 are removed. The removal is conducted with a liquid, gas, or plasma which is capable of removing selectively the masks without corrosion of photonic crystal base material 20 and substrate 10.

In the next step, as illustrated in FIG. 1J, coating film 40 and protecting films formed inside fine holes 125 are removed to bare the photonic crystal to complete the production of the main portion (basic skeleton) of the photonic crystal. If necessary, coating film 40 and the protecting films can be removed separately. The removal of coating film 40 and the protecting films is conducted with a liquid, gas, or plasma which is capable of removing selectively coating film 40 and the protecting films without corrosion of photonic crystal base material 20 and substrate 10.

The above removal of first mask 110, second mask 210, second-face-protecting mask 111, and alignment marker 112 may be conducted simultaneously with the removal of coating film 40. Since these masks are attached onto the surface of coating film 40, the removal of coating film 40 causes removal of the masks naturally.

The above process for producing a three-dimensional periodic structure is obviously suitable for any three-dimensional structure which can be formed by dry etching from the two faces. The three-dimensional structure may contain a non-periodic structure. As a simple example, a portion of the masks may be deformed to introduce a defect in the three-dimensional structure. In the above description, the working on the first face and the second face is conducted respectively once, but the working may be repeated several times, or another working method may be combinedly employed.

In the above embodiment, working is conducted by masking and etching at any two adjoining faces of a base material of the photonic crystal. The working may be conducted on one lateral face (or an end face) and another lateral face of a base material of a photonic crystal, or may be conducted on one main face (top face or surface) and one lateral face of a base material of a photonic crystal. Thus, suitable selection of the faces for the working enables adjustment of the crystal faces and the crystal orientation of the base material for the crystal faces and the crystal orientation of the photonic crystal after the working. Further, depending on the size of the photonic crystal to be formed, the face for working can be selected for ease of the working. The faces to be worked are preferably selected in consideration of the structure (design) of the intended photonic crystal, the working scale, and so forth.

As described above, the process for producing a three-dimensional photonic crystal according to the present invention enables production of a complicated three-dimensional structure, especially a three-dimensional nano-photonic crystal simply and precisely at a low cost. The produced device has improved properties, since the structure is continuous (seamless), and not causing inclusion of dust in the connecting part of the structure in the production process. Further, the process enables production of a structure in a shape which cannot be produced by a conventional technique. Thereby the freedom in the device design is increased and a novel function of the device can be realized.

FIG. 1J illustrates a three-dimensional photonic crystal produced according to the above process. In this three-dimensional periodic structure, the constitutional members are formed integrally. Therefore, the structure does not have isolated rods as the constitutional unit, being different from conventional woodpile structure. Therefore, in the present invention, the unit corresponding to the rod of the conventional wood-pile structure is defined as a column. In FIG. 1J, the numeral 1300 denotes the three-dimensional photonic crystal; the numeral 1301 denotes columns formed integrally according to the present invention, corresponding to the rods of conventional wood-pile structure; and the numeral 1305 denotes a cross-section of the column formed integrally.

### EXAMPLES

The present invention is described more specifically with reference to Examples without limiting the invention in any way.

### Example 1

In this Example, a three-dimensional photonic crystal is produced by working a photonic crystal base material through two adjoining lateral faces. The process of the production of the three-dimensional photonic crystal in this Example is basically the same as described above as the embodiment of the invention. Therefore the process of this Example is described with reference to FIGS. 1A-1J also.

In FIGS. 1A-1J, the numerals denote the followings: 10, a silicon (Si) substrate; 20, a photonic crystal base material derived from the Si substrate; 100, a first lateral face (first face) of photonic crystal base material 20; 200, a second lateral face (second face) adjoining to first face 100 of the photonic crystal base material; 31, a first angle of adjoining between first face 100 and second face 200.

Photonic crystal base material 20 is cut out from Si substrate 10 of about 500 μm thick by a semiconductor micro-fabrication process as illustrated in FIG. 1A. The micro-fabrication process includes photolithography employing a photoresist and anisotropic etching of Si by reactive ion beam etching. Obtained base material 20 has a height of about 100 μm. First face 100 and second face 200 have respectively a breadth of about 20 μm. First face 100 and second face 200 adjoin to each other at adjoining angle 31 of about 90°, and are nearly perpendicular to the main face of the substrate.

On the faces of base material 20 and substrate 10, a thermal oxidation film is formed as coating film 40 as illustrated in FIG. 1B. Specifically, base material 20 formed on substrate 10 is placed in a quartz furnace and is heat-treated in an oxygen atmosphere at about 900° C. for tens of minutes to form a SiO₂ coating film of about 0.5 μm thick on the surface of base material 20.

On first face 100 of the base material coated by coating film 40, first mask 110 is formed as illustrated in FIG. 1C. In this first-mask formation, to protect the coating film on second face 200, protection mask 111 is formed preliminarily in a breadth nearly equal to the thickness (about 0.5 μm) of coating film 40 on the edge portion of first face 100 adjoining to second face 200. Masks 110 and 111 are formed by implantation of Ga ions in a prescribed pattern by FIB of Ga into the surface layer of the mask formation face 100 at an accelerating voltage of about 30 kV. By the ion implantation, the surface of coating film 40 is carved in a depth of 5 to 20 nm. Thereby, Ga ions are allowed to distribute uniformly in the region from the surface to the depth of about 30 nm of the coating film 40 at the ion-injected portions. The maximum density of the Ga ions is controlled to be about 3×10²¹ cm⁻³ by decreasing the FIB beam diameter to about 10 nm and adjusting the beam current and the scanning speed. The arrangement period of the mask pattern is about 1 μm. Therefore, the three-dimensional photonic crystal to be formed has a length of about 20 arrangement periods in the lateral direction and a length of about 30 arrangement periods in the height direction.

The pattern of first mask 110 is transferred onto SiO₂ coating film 40 as illustrated in FIG. 1D. Specifically, the SiO₂ coating film on the first face is removed from the portions not protected by mask 110 or mask 111 by reactive ion etching employing a C₄F₈—O₂ gas mixture to bare the portions of first face 120 of Si under the coating film. In this etching operation, the SiO₂ coating film is etched off from the portions where Ga ions have not been implanted, whereas the SiO₂ film where Ga ions have been implanted is not etched. This is because the implanted Ga reacts chemically with fluorine to form a non-volatile Ga fluoride as a protecting mask on the surface for protection from the etching of the SiO₂ film.

Then, Si base material 20 is worked by reactive ion etching by a Bosch process by masking with masks 110, 111 and SiO₂ coating film 40 in the direction nearly perpendicular to first face 100 as illustrated in FIG. 1E. SF₆ gas is used as the etching gas and C₄F₈ gas is used for formation of the coating film (protection film). In these steps also, the formed Ga fluoride serves as the mask.

The above anisotropic etching treatment removes the portions of base material 20 not protected by masks 110, 111 or SiO₂ coating film 40 to bore fine holes 125 into base material 20 in the direction nearly perpendicular to first face 100.

Then, a thermal oxidation film is formed as protecting film inside fine holes 125. Specifically, The hole-formed sample is placed in a quartz furnace and is heat-treated in an oxygen atmosphere at about 900° C. for about ten minutes to form a SiO₂ protecting film of about 50 nm thick on the surfaces of inside walls of fine holes 125.

Then alignment marker 112 is formed by EB-CVD to indicate the position of fine holes 125 on first face 100 for aligning second mask 210 on second face 200. The material of marker 112 is exemplified by Pt. The Pt marker may contain an impurity like carbon without causing a trouble in the position marking.

On second face 200 of photonic crystal base material 20, second mask 210 is formed as illustrated in FIG. 1F in the same manner as in formation of first mask 110 on the aforementioned first face 100. The position of the second mask is adjusted relatively to the position of the first mask by utilizing the above alignment marker 112. Through the entire process for formation of the three-dimensional photonic crystal, the mask aligning is conducted only once, resulting in high working precision in the position adjustment.

The pattern of second mask 210 is transferred onto SiO₂ coating film 40 as illustrated in FIG. 1G. Thereby, the SiO₂ coating film on the second face is locally removed from the portions not protected by second mask 210 to bare the portions of second face 220 under the coating film in the same manner as in the working operation illustrated in FIG. 1D.

Then, Si base material 20 is worked by reactive ion etching by a Bosch process by masking with second mask 210 and SiO₂ coating film 40 in the direction nearly perpendicular to second face 200 as illustrated in FIG. 1H. This step is conducted in the same manner as in the step illustrated in FIG. 1E. This anisotropic etching treatment removes the portions of base material 20 not protected by mask 210 and SiO₂ coating film 40 to bore fine holes 225 into base material 20 in the direction nearly perpendicular to second face 200.

The masks (including first mask 110, second mask 210, and mask 111 for protecting the second face) are removed as illustrated in FIG. 1I, for example, by using a solution mixture containing HCl and pure water.

Then, SiO₂ coating film 40 and the protecting film inside fine holes 125 are removed to bare the photonic crystal to complete the production of the main portion of the photonic crystal as illustrated in FIG. 1J. The removal of SiO₂ coating film 40 and the removal of the protecting film inside fine holes 125 are conducted with a buffered hydrofluoric acid containing hydrofluoric acid and NH₄F as a buffer solution. In practical operation, the step of removal of the masks as illustrated in FIG. 1I may be omitted since the masks formed on the SiO₂ coating film can be removed entirely together with the SiO₂ coating film.

According to this Example, through the above steps, a woodpile type of three-dimensional photonic crystal of Si is obtained which has an arrangement period of 1 μm and lengths in the respective directions corresponding to about 20 arrangement periods or more.

### Example 2

In this Example, the main face (top face or surface) of the substrate and one lateral face of the substrate adjoining to the main face are worked to produce a three-dimensional photonic crystal. This Example 2 is different from Example 1 in the face to be worked by masking and etching. In Example 1 above, one lateral face and another lateral face adjoining thereto of the base material of the photonic crystal are worked, whereas in this Example 2, one main face and one lateral face adjoining thereto are worked.

Since this Example is different from Example 1 only in the above point, the descriptions common to Example 1 are omitted.

The production process of this Example is described below.

Firstly, main face 400 of a substrate is worked by a fine semiconductor working technique as illustrated in FIG. 2A. This fine working corresponds to the working of the first lateral face in Example 1. However, since main face 400 is worked on the top surface, the pattern can be formed not only by EB-CVD and FIB but also by photolithography, electron beam exposure, or a like method. Therefore fine patterns can be formed in plural regions simultaneously over a large area of the substrate face: different structures and different area sizes of patterns can be formed in the regions to meet the uses. Therefore, three-dimensional photonic crystals having different performances can be integrated as necessary.

Specifically, on main face 400 of Si substrate 10 of about 500 μm thick, thin films of Cr (about 5 nm thick) and Au (about 50 nm thick) are deposited successively by electron beam vapor deposition. An electron beam resist is applied on the thin metal film layer. The applied resist is subjected to electron beam exposure to form two-dimensional fine patterns in various shapes in plural regions of various area sizes. The patterns on the electron beam resist are transferred onto the thin Cr/Au film layer by ion milling, and the portions not protected by the electron beam resist of main face 400 of the Si substrate are bared. Then, the bared portions of main face 400 of the Si substrate is etched by reactive ion etching of Si in the direction nearly perpendicular to main face 400 of the Si substrate by a Bosch process. SF₆ gas is used for the etching, and C₄F₈ gas is used for formation of the coating film (protection film).

The anisotropic etching treatment forms deep fine holes perpendicular to main face 400 of the Si substrate in the portions of the Si substrate not protected by the electron beam resist and the metal thin film. The depth of the fine holes is about 30 μm in the finest patterns. Then the electron beam resist, the thin Au film, and the thin Cr film are removed respectively by a suitable etchant. Through the above-mentioned steps (not shown in the drawing), fine pattern regions 410 are formed on main face 400 as illustrated in FIG. 2A.

Then, the fine patterns are carved out by photolithography and deep etching of Si (Bosch process) to bare and shape the lateral wall faces of the fine pattern regions, as illustrated in FIG. 2B. For precise formation of the lateral wall faces, the etching is conducted in the direction nearly perpendicular to main face 400 of the substrate to an etching depth of 100 μm. By the deep etching, portion 11 of substrate 10 comes to constitute the bottom portions of the respective fine pattern regions. The regions to be etched on main face 400 are made to overlap fine pattern region 410: the etching is conducted to cut off the periphery of the fine pattern regions. In such a manner, plural base materials 20 of photonic crystals are formed which have respectively completed first face. The base materials have a height of about 100 μm, and lengths and breadths ranging respectively from about 5 μm to about 1 mm.

FIG. 2C is an enlarged view of a part of base material 20 of the photonic crystal. In the description below, the photonic crystal is assumed to have a woodpile structure having an arrangement period of about 1 μm, as an example. In the drawing, the numerals denote followings: 410, the first face; 420, the second face; 421, a groove; and 422, a flat portion of second face 420. In this base material, first face 410 and second face 420 are adjoined nearly perpendicularly to each other. The second face has a breadth of about 100 μm, namely the photonic crystal has a thickness corresponding to about 100 arrangement periods. The photonic crystal material, when viewed from the second face, has a thickness of about 20 μm: the thickness corresponding to 20 arrangement periods.

On the surfaces of base material 20 and substrate 10, as well as the inside walls of fine holes 4, a Si thermal-oxidized film (SiO₂) is formed as coating film 40 as shown in FIG. 2D in the same manner as in Example 1.

Thereafter, on second face 420 of the base material having coating film 40 formed thereon, prescribed masks are formed on second face 420 as illustrated in FIG. 2E. In this mask formation, owing to the projection-and-depression on the second face, masks are formed on grooves 421 and flat portions 422 respectively.

The shape of mask 450 formed on flat portions 422 is illustrated in the drawing. The shape of mask 455 formed on grooves 421 is illustrated in FIG. 2I. FIG. 2I is a sectional view of the photonic crystal base material taken along line 2I-2I in FIG. 2E in the direction parallel to second face 420. The masks are formed in the same manner as in Example 1, except that the alignment in the mask formation is made relatively to the grooves 421 on the second face. Thereby, the mask can be positioned at precision of 5 nm or higher in the lateral direction.

The alignment in the height direction is made by reference to the top edge of second face 420. A small positional deviation in the height direction affects only the thickness of the first top layer structure. In this process for formation of the three-dimensional photonic crystal, the mask alignment is conducted only once, resulting in high working precision with precise mask alignment.

The patterns of second masks 450 and 455 are transferred onto SiO₂ coating film 40 to bare Si portion 220 of second face 420 as illustrated in FIG. 2F in the same manner as in the pattern transfer in Example 1.

Then fine holes 225 are formed into base material 20 nearly perpendicularly to second face 420 by masking with second masks 450 and 455 and SiO₂ coating film 40 as illustrated in FIG. 2G in the same manner as the hole formation in Example 1.

Masks 450 and 455 and SiO₂ coating film 40 are removed to bare the photonic crystal as illustrated in FIG. 2H to complete the production of main portion of the photonic crystal. The removal of the masks and the coating film is conducted in the same manner as in Example 1.

Through the above steps, from Si as the material, a woodpile type of three-dimensional photonic crystal is obtained which has an arrangement period of 1 μm, and dimensions corresponding to not less than about 20 arrangement periods in respective each direction.

In FIG. 2H, the numeral 1300 denotes the three-dimensional photonic crystal, the numeral 1301 denotes the column formed integrally according to this Example, corresponding to the rod of conventional wood-pile structures, and the numeral 1305 denotes a section of the column formed integrally of this Example.

### Example 3

Example 3 describes a process for producing three-dimensional photonic crystals which have columns in various column sectional shapes: the columns having a uniform cross-sectional shape and a cross-sectional area in the column length direction.

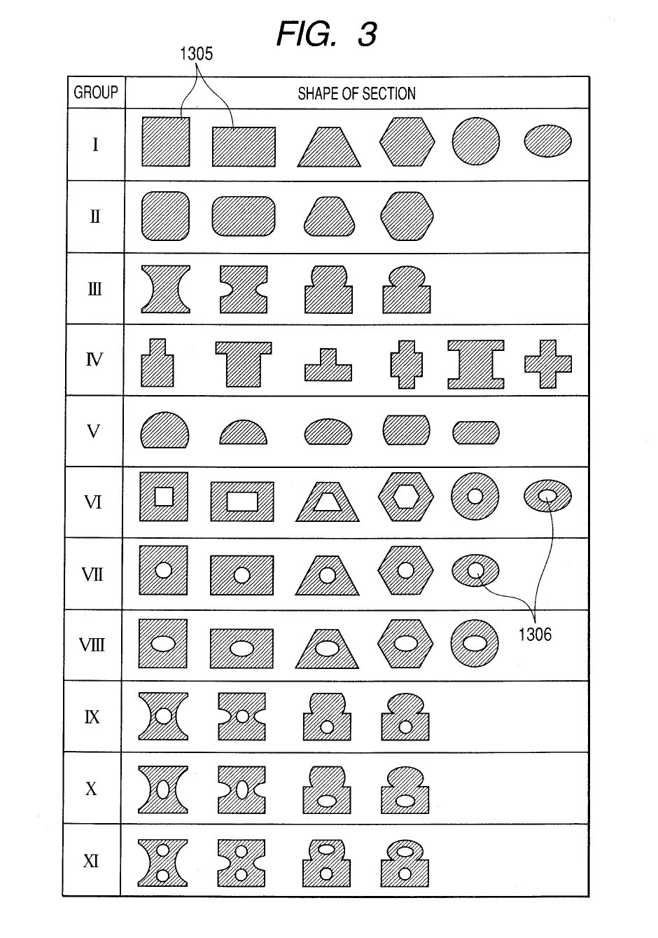

FIG. 3 illustrates cross-sectional shapes of the column of the three-dimensional periodic crystal.

The process for producing the three-dimensional photonic crystal of this Example forms integrally the columns in the three-dimensional structure. Therefore, no isolated rod is formed as the structural unit, being different from conventional wood-pile structures.

In the preceding descriptions, the cross-sectional shape of the column is rectangular. On the other hand in this Example, the three-dimensional photonic crystal can be constructed from rods having any cross-sectional shape.

FIG. 3 illustrates cross-sectional shapes of columns which can be produced according to the present invention, but the shapes are not limited thereto. FIG. 3 includes various structures which can be produced according to the present invention, but cannot be readily produced by conventional lamination processes: typical examples are columns having hollow 1306 of Groups VI to XI illustrated in FIG. 3.

The three-dimensional photonic crystal constructed from the columns having a cross-sectional shape illustrated in FIG. 3 can be produced by the process described in Example 1 or Example 2 of the present invention.

Specifically, a three-dimensional photonic crystal mentioned below can be constructed. That is, a three-dimensional photonic crystal has a three-dimensional periodic structure constituted from a plurality of striped layers in which columns are arranged parallel and periodically at a prescribed in-plane arrangement period; the striped layers are stacked in the thickness direction. This three-dimensional periodic structure is constructed of a stack of sets of striped layers. One set of the striped layers comprises four striped layers: a first striped layer containing plural columns placed parallel and periodically at an in-plane arrangement period; a second striped layer being laminated on the first striped layer and containing columns placed parallel periodically in the direction different from the arrangement direction of the columns in the first striped layer; a third striped layer being laminated on the second striped layer and containing columns placed parallel to each other periodically in the direction parallel to the columns in the first layer but displaced by half the arrangement period from the columns of the first striped layer; and a fourth striped layer being laminated on the third striped layer and containing columns placed parallel to each other periodically in the direction different from the arrangement direction of the columns in the second layer but displaced by half the arrangement period from the columns the second striped layer.

According to this Example, the columns in the respective striped layers can different cross-sectional shape as illustrated in FIG. 3, and the columns in the respective striped layers can have a hollow.

### Example 4

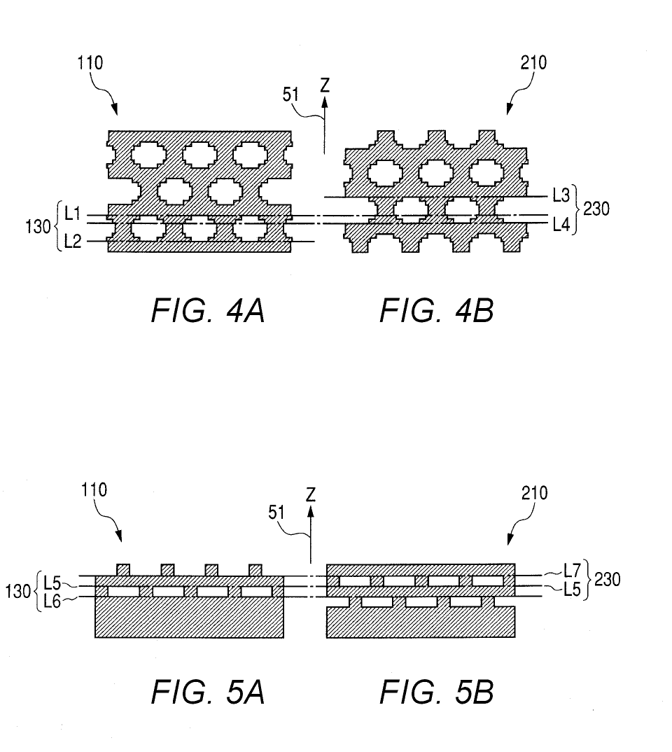

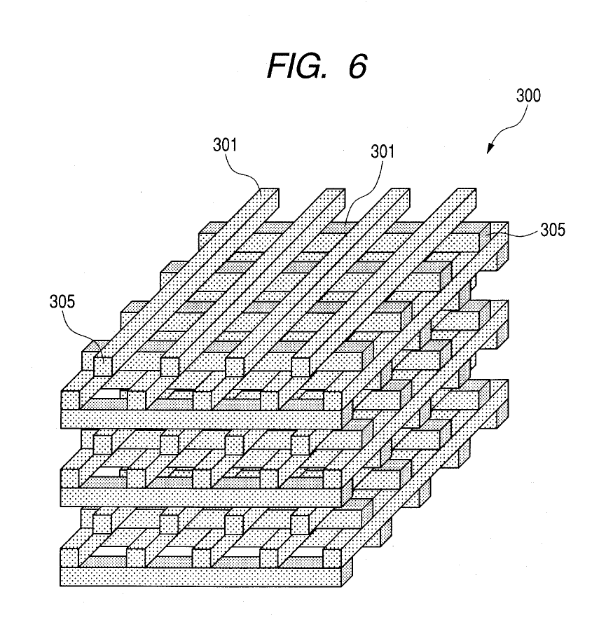

This Example describes, with reference to FIGS. 4, 5, 7A, and 7B, a structure in which the columns constituting the photonic crystal are not uniform in the cross-sectional shape and cross-sectional area along the length direction.

The three-dimensional photonic crystal of this Example can be produced through the process described in Example 1 or Example 2. Therefore, the details of the production process are not described here. This Example describes a structure of a joint-rod type three-dimensional photonic crystal to be produced and the mask for the production thereof.

When the cross-sectional shape and the cross-sectional area of the rods in the three-dimensional photonic crystal are arbitrarily variable in the rod length direction, the design of the device can be made flexible and the performance of the device can also be improved. For example, a the joint rod type of three-dimensional photonic crystal structure disclosed in U.S. Pat. No. 6,993,235 has a band gap broader than that of the woodpile structure of the photonic crystal.

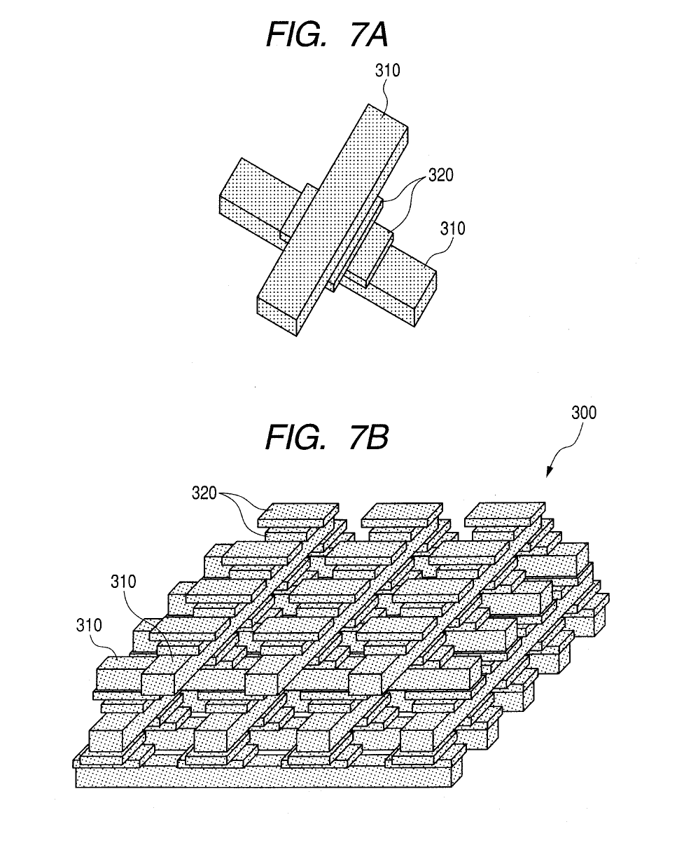

An example of the joint-rod structure is described with reference to FIGS. 7A and 7B. In the joint-rod structure shown in FIGS. 7A and 7B, two plate-shaped joints 320 are provided at the crossover point of the upper and lower rods 310. The length direction of each joint is made to conform to the length direction of each rod. The dimensions of the joint rod structure are, for example, as follows: rod length, about 100 μm; planar arrangement period of the rods, about 250 nm; rod layer number in thickness direction, 12 layers; rod breadth, about 80 nm; rod thickness, about 50 nm; joint breadth, about 100 nm; joint length, about 150 nm; joint thickness, about 20 nm.

FIG. 4 illustrates the mask for producing the above joint-rod structure in this Example. For ease of understanding, the first face and the second face are assumed to be perpendicular to each other and parallel in the z direction (direction indicated by arrow mark 51). FIG. 4 illustrates a part of first mask 110 to be formed on the first face, and a part of second mask 210 to be formed on the second face. Mask 110 and mask 210 are placed at the same height in the z direction. In FIG. 4, portion 130 of the first mask between contour lines L1 and L2 is employed for working one layer of the photonic crystal structure from the first face, and portion 230 of the second mask between contour lines L3 and L4 is employed for working another layer of the photonic crystal structure from the second face. Portion 130 of the first mask and portion 230 of the second mask serve for formation of two layers adjacent in z direction of the photonic crystal.

For comparison, first mask 110 and second mask 210 employed in production of the woodpile structure in Example 1 are illustrated partially in FIG. 5 in the same style as in FIG. 4. In FIG. 5, portion 130 of the first mask between contour lines L5 and L6 is employed for working the one layer of the photonic crystal structure from the first face: portion 230 of the second mask between contour lines L7 and L5 is employed for working one layer of the photonic crystal structure from the second face. Portion 130 of the first mask and portion 230 of the second mask are used for formation of two layers adjacent in z direction of the photonic crystal. As understood from contour lines L5, L6, and L7, the layer worked with mask 110 and the layer worked with mask 210 do not share a common portion and does not overlap. That is, the second mask is formed at a position not to cause contact with a portion of the first mask at the adjoining edge line between the first face and the second face. Thus, in working with mask 210, the layer worked through mask 110 is not worked through mask 210. Thereby the woodpile structure is produced in which the rod cross-sectional shape and the rod cross-sectional area are uniform along the rod length direction.

In contrast in this Example, as illustrated in FIG. 4, the layer worked through the mask 110 and the layer worked through mask 210 share contact portions in the z direction. For formation of the contact portion of the layers, the second mask is formed to have contact portions between the first mask and the second mask at the adjoining edge line between the first face and the second face. The contact portions are formed between the contour lines L1 and L4. At the contact portions, after working through first mask 110, the working is conducted again through second mask 210. By the double working, joint portion 320 is formed corresponding to the contact portion as illustrated in FIG. 7. That is, at crossing points of the columns of one striped layer and the columns of the adjacent striped layer, joint portions are formed which have respectively an area larger than the crossing region and directing to the length of the column portions. Therefore, the joint portions can be formed simultaneously with formation of not only the structure corresponding to rod portions 310 of a joint-rod structure but also a structure corresponding to rod joint portions 320 by two working operations with first mask 110 and second mask 210.

According to the technique of this Example, a three-dimensional photonic structure, which is not uniform in the cross-sectional shape and the cross-sectional area in the rod length direction, can be produced integrally.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-129022, filed May 15, 2007, which is hereby incorporated by reference herein in its entirety.

What is claimed is:

1. A process for producing a three-dimensional photonic crystal comprising the steps of:
providing a base material having first and second faces adjoining together at a first angle;
forming a first mask on the first face;
forming fine holes in the base material by dry-etching on the first face in a direction at a second angle to the first face;
forming a second mask on the second face; and
forming fine holes in the base material by dry-etching on the second face in a direction at a third angle to the second face;
the first mask and the second mask, being formed by implantation of ions by a focused ion beam onto the surface layer of the mask formation face of the base material.

2. The process for producing a three-dimensional photonic crystal according to claim 1, wherein the base material of the three-dimensional photonic crystal is formed from monocrystalline or amorphous Si or a Si compound.

3. The process for producing a three-dimensional photonic crystal according to claim 1, wherein the ions are Ga ions or In ions.

4. The process for producing a three-dimensional photonic crystal according to claim 1, wherein the process further comprises the steps of:
forming a coating film on at least a part of the face of the base material before formation of the first and second masks, and
removing at least a part of the coating film by etching treatment selectively after the formation of the first and second masks.

5. The process for producing a three-dimensional photonic crystal according to claim 4, wherein the step of forming the coating film is conducted by heat-treating the base material in an ambient gas to allow the surface component of the base material to react with the ambient gas to form an oxide film or nitride film on at least a part of the surface of the base material.

6. The process for producing a three-dimensional photonic crystal according to claim 1, wherein, in the steps of forming fine holes in the first face and the second face of the base material, the dry etching is conducted by reactive ion etching with a fluorine type gas.

7. The process for producing a three-dimensional photonic crystal according to claim 1, wherein, in the step of providing the base material, the first angle ranges from 10° to 170°.

8. The process for producing a three-dimensional photonic crystal according to claim 1, wherein, in the steps of forming fine holes through the first face and the second face of the base material, the second angle and the third angle ranges respectively from 10° to 90°.

9. The process for producing a three-dimensional photonic crystal according to claim 1, wherein, in formation of the second mask, the second mask is formed at a position not to overlap or to overlap partly with the first mask at the adjoining edge line between the first face and the second face.

10. The process for producing a three-dimensional photonic crystal according to claim 9, wherein, an alignment marker is formed on the first face for alignment of formation of the second mask.

11. A three-dimensional photonic crystal having a three-dimensional periodic structure constructed of sets of striped layers stacked in a layer thickness direction, one set of the striped layers comprising four striped layers: a first striped layer containing plural columns arranged parallel and periodically at an in-plane arrangement period; a second striped layer being laid on the first striped layer and containing columns arranged parallel periodically in the direction different from the arrangement direction of the columns in the first striped layer; a third striped layer being laid on the second striped layer and containing columns arranged parallel to each other periodically in the direction parallel to the columns in the first layer but displaced by half the arrangement period from the columns of the first striped layer; and a fourth striped layer being laid on the third striped layer and containing columns arranged parallel to each other periodically in the direction different from the arrangement direction of the columns in the second layer but displaced by half the arrangement period from the columns the second striped layer.

12. The three-dimensional photonic crystal according to claim 11, wherein the columns in the striped layers have different cross-sectional shapes.

13. The three-dimensional photonic crystal according to claim 12, wherein the columns in the striped layers have respectively a uniform cross-sectional shape and a uniform cross-sectional area along the column length direction.

14. The three-dimensional photonic crystal according to claim 11, wherein the columns in the striped layers have respectively a hollow.

15. The three-dimensional photonic crystal according to claim 11, wherein a joint portion is placed at the respective crossing regions of the columns extending in different directions, the joint portion having an area larger than that of the crossing region and being placed in the direction of the column length.
